(19) United States
(12) Patent Application Publication
(10) Pub. No.: US 2022/0154724 A1
(43) Pub. Date: May 19, 2022

(54) FLUID MACHINE

(71) Applicant: KABUSHIKI KAISHA TOYOTA JIDOSHOKKI, Aichi-ken (JP)

(72) Inventors: Hidefumi MORI, Kariya-shi (JP); Junya SUZUKI, Kariya-shi (JP)

(73) Assignee: KABUSHIKI KAISHA TOYOTA JIDOSHOKKI, Aichi-ken (JP)

(21) Appl. No.: 17/521,284

(22) Filed: Nov. 8, 2021

(30) Foreign Application Priority Data
Nov. 16, 2020 (JP) 2020-190510

(51) Int. Cl. F04D 25/06; F04D 29/056; F04D 17/10

(52) U.S. Cl. CPC F04D 25/0606; F04D 17/105; F04D 29/056

(57) ABSTRACT

A fluid machine includes a housing and a motor. The motor includes a rotor and a stator having a stator core. The rotor includes a tubular portion, a magnetic member, and a plug that is provided at one of a first end a second end of the tubular portion. The tubular portion includes first and second portions that protrude in an axial direction in relation to opposite ends of the stator core and opposite ends of the magnetic member. The first and second portions of the tubular portions are rotatably supported by two bearings, respectively. The magnetic member is spaced apart in the axial direction from the plug so that a space is defined in the tubular portion by the tubular portion, the magnetic member, and the plug. One of the two bearings is provided on a radially outer side of the space.

### BACKGROUND

### 1. Field

The present disclosure relates to a fluid machine.

### 2. Description of Related Art

A fluid machine includes an operating member located in a housing. The operating member draws fluid into and discharges the fluid from the housing. Some fluid machines include a motor that is accommodated in the housing and rotates the operating member. The motor includes a stator and a rotor. The stator includes a tubular stator core fixed to the inner circumferential surface of the housing, and the rotor is arranged on the radially inner side of the stator. The rotor may include a tubular portion, a magnetic member fixed to the inner circumferential surface of the tubular portion, and a plug that is provided at at least one of the opposite ends of the tubular portion and fixed to the inner circumferential surface of the tubular portion. The fluid machine also includes two bearings that rotatably support the rotor. As disclosed in Japanese Laid-Open Patent Publication No. 2004-112849, a plug provided at one of the opposite ends of the tubular portion and another plug provided at the other end of the tubular portion may be each rotatably supported by a bearing. In this manner, one of two bearings supports a plug provided at one of the opposite ends of a tubular portion, and the other bearing supports a plug provided at the other end of the tubular portion.

In a case in which one of two bearings supports a plug provided at one of the opposite ends of a tubular portion, and the other bearing supports a plug provided at the other end of the tubular portion as disclosed in Japanese Laid-Open Patent Publication No. 2004-112849, the concentricity of the rotor in relation to the two bearings cannot be achieved easily due to dimensional tolerances of the plugs. Magnetic flux between an end face of the magnetic member and the stator core may leak through one of the two bearings. Also, magnetic flux between the other end face of the magnetic member and the stator core may leak through the other bearing. Such magnetic flux leakage is desired to be reduced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fluid machine includes a housing that includes an inner circumferential surface, an operating member that is configured to draw fluid into and discharge the fluid from the housing, and a motor that is accommodated in the housing and is configured to rotate the operating member. The motor includes a stator and a rotor. The stator is fixed to the inner circumferential surface of the housing and includes a stator core. The stator core includes a first end face and a second end face. The second end face is on a side opposite to the first end face. The rotor is arranged on a radially inner side of the stator. The rotor includes a tubular portion, a magnetic member, and a plug. The tubular portion includes an inner circumferential surface and includes, in an axial direction of the tubular portion, a first end and a second end. The second end is on a side opposite to the first end. The magnetic member is fixed to the inner circumferential surface of the tubular portion and includes a first end face and a second end face. The second end face is on a side opposite to the first end face. The plug is provided at one of the first end and the second end of the tubular portion. The fluid machine includes two bearings that rotatably support the rotor. The tubular portion includes a first portion that protrudes in the axial direction in relation to the first end face of the stator core and the first end face of the magnetic member. The tubular portion includes a second portion that protrudes in the axial direction in relation to the second end face of the stator core and the second end face of the magnetic member. The first portion and the second portion of the tubular portion are rotatably supported by the two bearings, respectively. The magnetic member is spaced apart in the axial direction from the plug so that a space is defined inside the tubular portion by the tubular portion, the magnetic member, and the plug. One of the two bearings is provided on a radially outer side of the space.

Other aspects and advantages of the present disclosure will become apparent from the following description, taken in conjunction with the accompanying drawings, illustrating exemplary embodiments.

### BRIEF DESCRIPTION OF THE DRAWINGS

FIG. 1 is a cross-sectional side view illustrating a fluid machine according to an embodiment.

FIG. 2 is an enlarged cross-sectional view illustrating part of the fluid machine.

FIG. 3 is a cross-sectional side view illustrating a fluid machine according to another embodiment.

FIG. 4 is an enlarged cross-sectional view illustrating part of the fluid machine shown in FIG. 3.

FIG. 5 is a cross-sectional side view illustrating a fluid machine according to a further embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

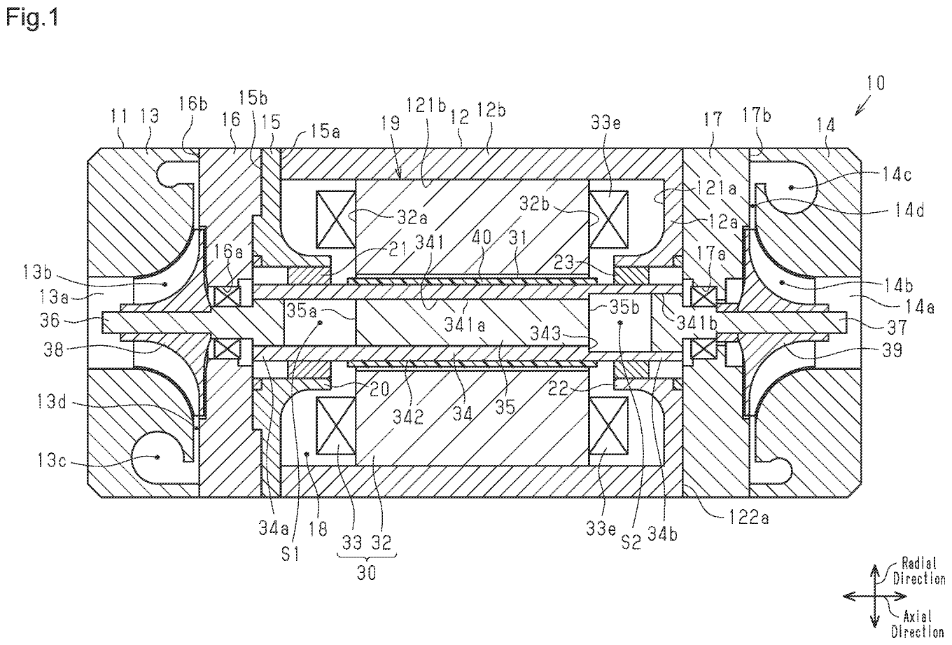

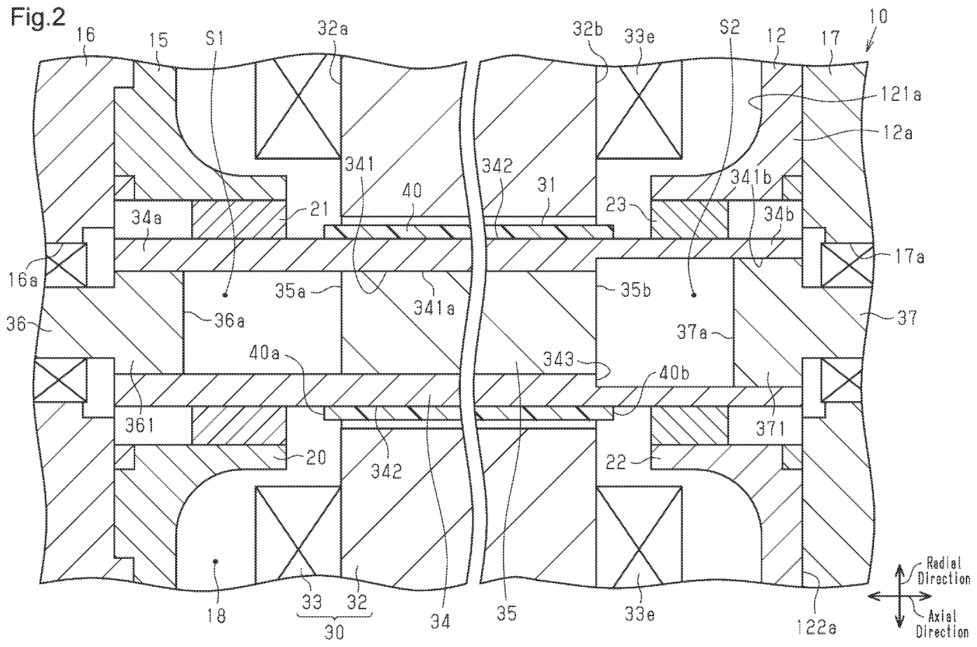

A fluid machine 10 according to an embodiment will now be described with reference to FIGS. 1 and 2. The fluid machine 10 of the present embodiment is mounted on a fuel cell vehicle. The fuel cell vehicle includes a fuel cell system, to which oxygen and hydrogen are supplied to generate power. The fluid machine 10 compresses air, which is fluid and contains oxygen supplied to a fuel cell.

As shown in FIG. 1, the fluid machine 10 includes a housing 11. The housing 11 of the fluid machine 10 is tubular. The housing 11 includes a motor housing member 12, a first compressor housing member 13, a second compressor housing member 14, a first plate 15, a second plate 16, and a third plate 17. The motor housing member 12 includes a plate-shaped bottom wall 12a and a tubular peripheral wall 12b, which extends from the outer circumference of the bottom wall 12a. The motor housing 12 is a tube with a closed end. The first plate 15 is coupled to an end of the peripheral wall 12b of the motor housing member 12 that is close to an opening so as to close the opening of the peripheral wall 12b of the motor housing member 12.

The housing 11 includes a motor chamber 18. The motor chamber 18 is defined by an inner surface 121a of the bottom wall 12a of the motor housing member 12, an inner circumferential surface 121b of the peripheral wall 12b of the motor housing member 12, and an end face 15a of the first plate 15 that is closer to the motor housing member 12. The fluid machine 10 includes a motor 19. The motor 19 is accommodated in the motor chamber 18. The motor 19 is thus accommodated in the housing 11.

The first plate 15 includes a first bearing retaining portion 20. The first bearing retaining portion 20 is tubular. The first bearing retaining portion 20 retains a first air bearing 21, which is a bearing. The first air bearing 21 is cylindrical. The interior of the first bearing retaining portion 20 extends through the first plate 15. The first bearing retaining portion 20 includes an opening in an end face 15b of the first plate 15 on a side opposite to the motor housing member 12.

The motor housing member 12 includes a second bearing retaining portion 22. The second bearing retaining portion 22 is cylindrical. The second bearing retaining portion 22 protrudes toward the motor 19 from the inner surface 121a of the bottom wall 12a of the motor housing member 12. The second bearing retaining portion 22 retains a second air bearing 23, which is a bearing. The second air bearing 23 is cylindrical. The interior of the second bearing retaining portion 22 extends through the bottom wall 12a of the motor housing member 12. The second bearing retaining portion 22 includes an opening in an outer surface 122a of the bottom wall 12a. The axis of the first bearing retaining portion 20 and the axis of the second bearing retaining portion 22 are aligned with each other. Also, the axis of the first air bearing 21 and the axis of the second air bearing 23 are aligned with each other.

The second plate 16 is coupled to the end face 15b of the first plate 15. The second plate 16 includes a second shaft insertion hole 16a in a center portion. The second shaft insertion hole 16a is continuous with the interior of the first bearing retaining portion 20. The axis of the second shaft insertion hole 16a is aligned with the axis of the first bearing retaining portion 20.

The third plate 17 is coupled to the outer surface 122a of the bottom wall 12a of the motor housing member 12. The third plate 17 includes a third shaft insertion hole 17a in a center portion. The third shaft insertion hole 17a is continuous with the interior of the second bearing retaining portion 22. The axis of the third shaft insertion hole 17a is aligned with the axis of the second bearing retaining portion 22.

The first compressor housing member 13 is tubular. The first compressor housing member 13 includes a first suction port 13a. The first suction port 13a is a circular hole. Air is drawn into the first suction port 13a. The first compressor housing member 13 is coupled to an end face 16b of the second plate 16 on a side opposite to the first plate 15 with the axis of the first suction port 13a being aligned with the axis of the second shaft insertion hole 16a of the second plate 16 and the axis of the first bearing retaining portion 20. The first suction port 13a includes an opening in an end face of the first compressor housing member 13 on a side opposite to the second plate 16. A first impeller chamber 13b, a first discharge chamber 13c, and a first diffuser passage 13d are provided between the first compressor housing member 13 and the second plate 16. The first impeller chamber 13b is continuous with the first suction port 13a. The first discharge chamber 13c is located around the first impeller chamber 13b and extends about the axis of the first suction port 13a. The first diffuser passage 13d connects the first impeller chamber 13b and the first discharge chamber 13c to each other. The first impeller chamber 13b is continuous with the second shaft insertion hole 16a of the second plate 16.

The second compressor housing member 14 is tubular. The second compressor housing member 14 includes a second suction port 14a. The second suction port 14a is a circular hole. Air is drawn into the second suction port 14a. The second compressor housing member 14 is coupled to an end face 17b of the third plate 17 on a side opposite to the motor housing member 12 with the axis of the second suction port 14a being aligned with the axis of the third shaft insertion hole 17a of the third plate 17 and the axis of the second bearing retaining portion 22. The second suction port 14a includes an opening in an end face of the second compressor housing member 14 on a side opposite to the third plate 17. A second impeller chamber 14b, a second discharge chamber 14c, and a second diffuser passage 14d are provided between the second compressor housing member 14 and the end face 17b of the third plate 17. The second impeller chamber 14b connects the second suction port 14a and the third shaft insertion hole 17a to each other. The second discharge chamber 14c is located around the second impeller chamber 14b and extends about the axis of the second suction port 14a. The second diffuser passage 14d connects the second impeller chamber 14b and the second discharge chamber 14c to each other.

The motor 19 includes a stator 30 and a rotor 31. The stator 30 is fixed to the peripheral wall 12b of the motor housing member 12. The stator 30 includes a tubular stator core 32 and a coil 33. The stator core 32 is fixed to the inner circumferential surface 121b of the peripheral wall 12b of the motor housing member 12. The coil 33 is wound about the stator core 32. The motor 19 includes coil ends 33e. The coil ends 33e are parts of the coil 33 and respectively protrude from a first end face 32a and a second end face 32b of the stator core 32. The first end face 32a of the stator core 32 is one of the opposite surfaces of the stator core 32, and the second end face 32b of the stator core 32 is other one of the opposite surfaces of the stator core 32.

The rotor 31 includes a tubular portion 34, a permanent magnet 35, which is a magnetic member, a first shaft member 36, which is a plug, and a second shaft member 37, which is a plug. The tubular portion 34 is made of, for example, metal. The tubular portion 34 is cylindrical. An inner circumferential surface 341 of the tubular portion 34 includes a first inner circumferential surface 341a and a second inner circumferential surface 341b. The inner diameter of the first inner circumferential surface 341a is smaller than the inner diameter of the second inner circumferential surface 341b. The first inner circumferential surface 341a and the second inner circumferential surface 341b are connected to each other by an annular step surface 343. The step surface 343 extends in the radial direction of the tubular portion 34.

As shown in FIG. 2, the permanent magnet 35 has the shape of a solid column. The permanent magnet 35 is fixed to the inner circumferential surface 341 of the tubular portion 34 by being press-fitted to part of the first inner circumferential surface 341a of the tubular portion 34 that is closer to the second inner circumferential surface 341b. The axis of the permanent magnet 35 is aligned with the axis of the tubular portion 34. The length in the axial direction of the permanent magnet 35 is shorter than the length in the axial direction of the tubular portion 34. A first end face 35a and a second end face 35b in the axial direction of the permanent magnet 35 are flat surfaces that extend in a direction orthogonal to the axial direction. The first end face 35a of the permanent magnet 35 is an end face of the permanent magnet 35, and the second end face 35b of the permanent magnet 35 is another end face of the permanent magnet 35. The permanent magnet 35 is magnetized in the radial direction of the permanent magnet 35.

The first end face 35a of the permanent magnet 35 is located on the inner side of the first inner circumferential surface 341a of the tubular portion 34. Thus, a first end 34a of the tubular portion 34 protrudes from the first end face 35a of the permanent magnet 35. Therefore, the first end 34a of the tubular portion 34 is a first portion, which protrudes in the axial direction in relation to the first end face 35a of the permanent magnet 35. The second end face 35b of the permanent magnet 35 overlaps with the step surface 343 of the tubular portion 34 when viewed in the radial direction of the tubular portion 34. In other words, the second end face 35b of the permanent magnet 35 is flush with the step surface 343 of the tubular portion 34. Thus, a second end 34b of the tubular portion 34 protrudes from the second end face 35b of the permanent magnet 35. Therefore, the second end 34b of the tubular portion 34 is a second portion, which protrudes in the axial direction in relation to the second end face 35b of the permanent magnet 35.

For example, the permanent magnet 35 is inserted into the tubular portion 34 through an opening of the second end 34b of the tubular portion 34. Then, the permanent magnet 35 passes through the interior of the second inner circumferential surface 341b of the tubular portion 34, so that the first end face 35a of the permanent magnet 35 reaches the step surface 343. When the permanent magnet 35 is inserted further, the permanent magnet 35 is press-fitted into the first inner circumferential surface 341a. The permanent magnet 35 is press-fitted until the second end face 35b of the permanent magnet 35 overlaps with the step surface 343 when viewed in the radial direction of the tubular portion 34, that is, until the second end face 35b of the permanent magnet 35 is flush with the step surface 343. This fixes the permanent magnet 35 to the inner circumferential surface 341 of the tubular portion 34 with the permanent magnet 35 press-fitted to the portion of the first inner circumferential surface 341a of the tubular portion 34 that is closer to the second inner circumferential surface 341b.

The length in the axial direction of the tubular portion 34 is longer than the length in the axial direction of the stator core 32. The first end 34a of the tubular portion 34 protrudes in relation to the first end face 32a of the stator core 32. Thus, the first end 34a of the tubular portion 34 is part of the tubular portion 34 that protrudes in the axial direction in relation to the first end face 32a of the stator core 32. The second end 34b of the tubular portion 34 protrudes in relation to the second end face 32b of the stator core 32. Thus, the second end 34b of the tubular portion 34 is part of the tubular portion 34 that protrudes in the axial direction in relation to the second end face 32b of the stator core 32. Therefore, the opposite ends of the tubular portion 34 are parts of the tubular portion 34 that protrude in the axial direction of the tubular portion 34 in relation to the opposite ends of the stator core 32 and the opposite ends of the permanent magnet 35. The rotor 31 is located on the radially inner side of the stator 30.

The first shaft member 36 includes a columnar first fixing portion 361. The first shaft member 36 is provided at the first end 34a of the tubular portion 34. The first shaft member 36 is fixed to the inner circumferential surface 341 of the tubular portion 34 by press-fitting the first fixing portion 361 of the first shaft member 36 into the first inner circumferential surface 341a of the tubular portion 34.

The second shaft member 37 includes a columnar second fixing portion 371. The outer diameter of the second fixing portion 371 is larger than the outer diameter of the first fixing portion 361. The second shaft member 37 is provided at the second end 34b of the tubular portion 34. The second shaft member 37 is fixed to the inner circumferential surface 341 of the tubular portion 34 by press-fitting the second fixing portion 371 of the second shaft member 37 into the first inner circumferential surface 341a of the tubular portion 34. Accordingly, the rotor 31 includes the first shaft member 36 and the second shaft member 37 as plugs at the ends in the axial direction of the tubular portion 34.

As shown in FIG. 1, a first impeller 38 is coupled to an end of the first shaft member 36 that is opposite to the tubular portion 34. The first impeller 38 is integrally rotatable with the first shaft member 36. That is, the motor 19 is configured to rotate the first impeller 38. The first impeller 38 draws air into and discharges the air from the housing 11. A second impeller 39 is coupled to an end of the second shaft member 37 that is on a side opposite to the tubular portion 34. The second impeller 39 is integrally rotatable with the second shaft member 37. That is, the motor 19 is configured to rotate the second impeller 39. The second impeller 39 draws air into and discharges the air from the housing 11. Therefore, the first impeller 38 and the second impeller 39 are operating members that are configured to draw air into and discharge air from the housing 11.

The first air bearing 21 rotatably supports the first end 34a of the tubular portion 34. Therefore, the first air bearing 21 rotatably supports the first end 34a, which is the part of the tubular portion 34 that protrudes in the axial direction in relation to the first end face 32a of the stator core 32 and the first end face 35a of the permanent magnet 35. The axis of the first air bearing 21 is aligned with the axis of the tubular portion 34.

As shown in FIG. 2, the second air bearing 23 rotatably supports the second end 34b of the tubular portion 34. Therefore, the second air bearing 23 rotatably supports the second end 34b, which is the part of the tubular portion 34 that protrudes in the axial direction in relation to the second end face 32b of the stator core 32 and the second end face 35b of the permanent magnet 35. Thus, the parts of the tubular portion 34 that respectively protrude in the axial direction in relation to the opposite end faces of the stator core 32 and the opposite end faces of the permanent magnet 35 are rotatably supported by the first air bearing 21 and the second air bearing 23. The axis of the second air bearing 23 is aligned with the axis of the tubular portion 34.

A first space S1 and a second space S2 are defined inside the tubular portion 34. The first space S1 is located between the permanent magnet 35 and the first shaft member 36. Therefore, the permanent magnet 35 is spaced apart in the axial direction from the first shaft member 36. The first space S1 overlaps with the first air bearing 21 when viewed in the radial direction of the tubular portion 34 while being adjacent to the first end face 35a of the permanent magnet 35. In the present embodiment, the first space S1 is defined by the inner circumferential surface 341 of the tubular portion 34, the first end face 35a of the permanent magnet 35, and an end face 36a of the first shaft member 36. Thus, the permanent magnet 35 is spaced apart in the axial direction from the first shaft member 36 in the tubular portion 34, so that the tubular portion 34, the permanent magnet 35, and the first shaft member 36 define the first space S1.

The first end face 35a of the permanent magnet 35 overlaps with the first end face 32a of the stator core 32 when viewed in the radial direction of the tubular portion 34. The first end face 35a of the permanent magnet 35 and the first end face 32a of the stator core 32 are disposed in the same plane. Thus, the first end face 35a of the permanent magnet 35 overlaps, when viewed in the radial direction of the tubular portion 34, with part of the tubular portion 34 that is closer to the second end 34b than part of the tubular portion 34 that is supported by the first air bearing 21, but does not overlap with the first air bearing 21 when viewed in the radial direction of the tubular portion 34. Also, the end face 36a of the first shaft member 36 overlaps, when viewed in the radial direction of the tubular portion 34, with the part of the tubular portion 34 that is closer to the opening of the first end 34a than the part of the tubular portion 34 that is supported by the first air bearing 21, but does not overlap with the first air bearing 21 when viewed in the radial direction of the tubular portion 34. Therefore, the first air bearing 21 supports the tubular portion 34 within the range of the length in the axial direction of the first space S1.

The second space S2 is located between the permanent magnet 35 and the second shaft member 37. Therefore, the permanent magnet 35 is spaced apart in the axial direction from the second shaft member 37. The second space S2 overlaps with the second air bearing 23 when viewed in the radial direction of the tubular portion 34, while being adjacent to the second end face 35b of the permanent magnet 35. In the present embodiment, the second space S2 is defined by the inner circumferential surface 341 of the tubular portion 34, the second end face 35b of the permanent magnet 35, and an end face 37a of the second shaft member 37. Thus, the permanent magnet 35 is spaced apart in the axial direction from the second shaft member 37 in the tubular portion 34, so that the tubular portion 34, the permanent magnet 35, and the second shaft member 37 define the second space S2. That is, the first space S1 and the second space S2 are respectively disposed on the opposite sides in the axial direction of the permanent magnet 35. The first air bearing 21 is provided on the radially outer side of the first space S1. Likewise, the second air bearing 23 is provided on the radially outer side of the second space S2.

The second end face 35b of the permanent magnet 35 overlaps with the second end face 32b of the stator core 32 when viewed in the radial direction of the tubular portion 34. The second end face 35b of the permanent magnet 35 and the second end face 32b of the stator core 32 are disposed in the same plane. Thus, the second end face 35b of the permanent magnet 35 overlaps, when viewed in the radial direction of the tubular portion 34, with part of the tubular portion 34 that is closer to the first end 34a than part of the tubular portion 34 that is supported by the second air bearing 23, but does not overlap with the second air bearing 23 when viewed in the radial direction of the tubular portion 34. Also, the end face 37a of the second shaft member 37 overlaps, when viewed in the radial direction of the tubular portion 34, with the part of the tubular portion 34 that is closer to the opening of the second end 34b than the part of the tubular portion 34 that is supported by the second air bearing 23, but does not overlap with the second air bearing 23 when viewed in the radial direction of the tubular portion 34. Therefore, the second air bearing 23 supports the tubular portion 34 within the range of the length in the axial direction of the second space S2.

The rotor 31 further includes a protective portion 40. The protective portion 40 is cylindrical. The protective portion 40 is fixed to an outer circumferential surface 342 of the tubular portion 34. The length of the protective portion 40 in the axial direction of protective portion 40 is longer than the length of the permanent magnet 35 in the axial direction of the permanent magnet 35. In the axial direction, the first end face 35a of the permanent magnet 35 is closer to a second end face 40b of the protective portion 40 than a first end face 40a of the protective portion 40, and the second end face 35b of the permanent magnet 35 is closer to the first end face 40a of the protective portion 40 than the second end face 40b of the protective portion 40. Thus, the protective portion 40 is fixed to the outer circumferential surface 342 of the tubular portion 34 in a position overlapping with the permanent magnet 35 when viewed in the radial direction of the tubular portion 34. The protective portion 40 is made of, for example, carbon fiber reinforced plastic. Therefore, the protective portion 40 has a greater tensile strength than the tubular portion 34.

Operation of the present embodiment will now be described.

The air drawn through the first suction port 13a is compressed by rotation of the first impeller 38 in the first impeller chamber 13b, and is discharged from the first discharge chamber 13c through the first diffuser passage 13d. The air discharged from the first discharge chamber 13c is drawn to the second suction port 14a via piping (not shown) and is compressed again by rotation of the second impeller 39 in the second impeller chamber 14b. The air then flows through the second diffuser passage 14d to be discharged from the second discharge chamber 14c. The air discharged from the second discharge chamber 14c is supplied to the fuel cell via piping (not shown).

An example assumes that the first air bearing 21 supports the first shaft member 36 provided at the first end 34a of the tubular portion 34, and that the second air bearing 23 supports the second shaft member 37 provided at the second end 34b of the tubular portion 34. In this case, the concentricity of the rotor 31 in relation to the first air bearing 21 and the second air bearing 23 cannot be achieved easily due to the dimensional tolerances of the first shaft member 36 and the second shaft member 37.

In this regard, the first air bearing 21 supports the first end 34a of the tubular portion 34, and the second air bearing 23 supports the second end 34b of the tubular portion 34 in the present embodiment. This allows the concentricity of the rotor 31 in relation to the first air bearing 21 and the second air bearing 23 to be achieved easily, allowing the rotor 31 to rotate in a stable manner

A comparative example will now be considered in which the first space S1 does not overlap with the first air bearing 21, and the second space S2 does not overlap with the second air bearing 23, that is, the entire first air bearing 21 overlaps with the first shaft member 36 when viewed in the radial direction of the tubular portion 34, and the entire second air bearing 23 overlaps with the second shaft member 37 when viewed in the radial direction of the tubular portion 34. In this case, magnetic flux may leak, for example, from the first end face 35a of the permanent magnet 35 to the first end face 32a of the stator core 32 through the first shaft member 36, the first end 34a of the tubular portion 34, the first air bearing 21, and the first bearing retaining portion 20. Also, magnetic flux may leak, for example, from the first end face 32a of the stator core 32 to the first end face 35a of the permanent magnet 35 through the first bearing retaining portion 20, the first air bearing 21, the first end 34a of the tubular portion 34, and the first shaft member 36.

Likewise, magnetic flux may leak, for example, from the second end face 35b of the permanent magnet 35 to the second end face 32b of the stator core 32 through the second shaft member 37, the second end 34b of the tubular portion 34, the second air bearing 23, and the second bearing retaining portion 22. Also, magnetic flux may leak, for example, from the second end face 32b of the stator core 32 to the second end face 35b of the permanent magnet 35 through the second bearing retaining portion 22, the second air bearing 23, the second end 34b of the tubular portion 34, and the second shaft member 37.

In this regard, the present embodiment includes the first space S1 and the second space S2 on the inner side of the tubular portion 34. The first air bearing 21 supports the tubular portion 34 within the range in the axial direction of the first space S1, and the second air bearing 23 supports the tubular portion 34 within the range in the axial direction of the second space S2. Accordingly, the first space S1, for example, reduces the magnetic flux leakage from the first end face 35a of the permanent magnet 35 to the first air bearing 21 through the first end 34a of the tubular portion 34. Also, the first space S1, for example, reduces the magnetic flux leakage from the first end face 32a of the stator core 32 to the first end face 35a of the permanent magnet 35 through the first bearing retaining portion 20, the first air bearing 21, and the first end 34a of the tubular portion 34. This suppresses the magnetic flux leakage between the permanent magnet 35 and the stator core 32 via the first air bearing 21.

Likewise, the second space S2, for example, reduces the magnetic flux leakage from the second end face 35b of the permanent magnet 35 to the second air bearing 23 through the second end 34b of the tubular portion 34. Also, the second space S2, for example, reduces magnetic flux leakage from the second end face 32b of the stator core 32 to the second end face 35b of the permanent magnet 35 through the second bearing retaining portion 22, the second air bearing 23, and the second end 34b of the tubular portion 34. This reduces the magnetic flux leakage between the permanent magnet 35 and the stator core 32 via the second air bearing 23. This limits reduction in the out put of the motor 19.

The above-described embodiment has the following advantages.

(1) The first air bearing 21 supports the first end 34a, which is the part of the tubular portion 34 that protrudes in the axial direction in relation to the first end face 32a of the stator core 32 and the first end face 35a of the permanent magnet 35. Also, the second air bearing 23 supports the second end 34b, which is the part of the tubular portion 34 that protrudes in the axial direction in relation to the second end face 32b of the stator core 32 and the second end face 35b of the permanent magnet 35. This eliminates the problem that the concentricity of the rotor 31 in relation to the first air bearing 21 and the second air bearing 23 cannot be achieved easily due to the dimensional tolerances of the first shaft member 36 and the second shaft member 37, as in the case of the related art described in the BACKGROUND section, in which the first air bearing 21 supports the first shaft member 36 provided at the first end 34a of the tubular portion 34, and that the second air bearing 23 supports the second shaft member 37 provided at the second end 34b of the tubular portion 34. Accordingly, the concentricity of the rotor 31 in relation to the first air bearing 21 and the second air bearing 23 is achieved easily.

The permanent magnet 35 is spaced apart in the axial direction from the first shaft member 36 in the tubular portion 34, so that the tubular portion 34, the permanent magnet 35, and the first shaft member 36 define the first space S1. The first air bearing 21 is provided on the radially outer side of the first space S1. Also, the permanent magnet 35 is spaced apart in the axial direction from the second shaft member 37 in the tubular portion 34, so that the tubular portion 34, the permanent magnet 35, and the second shaft member 37 define the second space S2. The second air bearing 23 is provided on the radially outer side of the second space S2. This reduces the magnetic flux leakage between the first end face 35a of the permanent magnet 35 and the stator core 32 through the first air bearing 21 and the magnetic flux leakage between the second end face 35b of the permanent magnet 35 and the stator core 32 through the second air bearing 23. Accordingly, the above-described embodiment reduces magnetic flux leakage while allowing the concentricity of the rotor 31 in relation to the first air bearing 21 and the second air bearing 23 to be achieved easily.

(2) The first space S1 and the second space S2 are defined inside the tubular portion 34. This reduces both the magnetic flux leakage between the first end face 35a in the axial direction of the permanent magnet 35 and the stator core 32 through the first air bearing 21 and the magnetic flux leakage between the second end face 35b of the permanent magnet 35 and the stator core 32 through the second air bearing 23. The present embodiment thus further efficiently reduces magnetic flux leakage.

(3) The first air bearing 21 supports the tubular portion 34 within the range in the axial direction of the first space S1, and the second air bearing 23 supports the tubular portion 34 within the range in the axial direction of the second space S2. For example, an example assumes that part of the first air bearing 21 supports the tubular portion 34 outside the range in the axial direction of the first space S1, and part of the second air bearing 23 supports the tubular portion 34 outside the range in the axial direction of the second space S2. As compared to this example, the above-described embodiment readily reduces the magnetic flux leakage between the first end face 35a of the permanent magnet 35 and the stator core 32 through the first air bearing 21 and the magnetic flux leakage between the second end face 35b of the permanent magnet 35 and the stator core 32 through the second air bearing 23.

(4) The rotor 31 further includes the tubular protective portion 40 that has a tensile strength greater than that of the tubular portion 34. The protective portion 40 is fixed to the outer circumferential surface 342 of the tubular portion 34 in a position overlapping with the permanent magnet 35 when viewed in the radial direction of the tubular portion 34. The protective portion 40 suppresses deformation of the permanent magnet 35 that would be caused by centrifugal force generated by rotation of the rotor 31.

(5) The tubular portion 34 is made of metal. Accordingly, the dimensions of the tubular portion 34 are unlikely to be changed by heat as compared to a case in which the tubular portion 34 is made of, for example, carbon fiber reinforced plastic. This limits increase in the amount of imbalance of the entire rotor 31.

(6) If the tubular portion 34 is made of carbon fiber reinforced plastic, the parts supported by the first air bearing 21 and the second air bearing 23 need to include metal components. However, since the tubular portion 34, which is made of metal, is supported by the first air bearing 21 and the second air bearing 23 in the present embodiment, no additional metal components are needed. Thus, the number of components is reduced.

(7) The first air bearing 21 does not overlap with the first shaft member 36 when viewed in the radial direction of the tubular portion 34, and the second air bearing 23 does not overlap with the second shaft member 37 when viewed in the radial direction of the tubular portion 34. Accordingly, even if the heat of the first shaft member 36 and the second shaft member 37 deform the parts of the tubular portion 34 to which the first shaft member 36 and the second shaft member 37 are fixed, the clearance between the tubular portion 34 and the first air bearing 21 and the clearance between the tubular portion 34 and the second air bearing 23 will be maintained.

(8) The entire first air bearing 21 does not overlap with the first shaft member 36 when viewed in the radial direction of the tubular portion 34, and the entire second air bearing 23 does not overlap with the second shaft member 37 when viewed in the radial direction of the tubular portion 34. Accordingly, even if variation in the interference between the tubular portion 34 and the first air bearing 21 and interference between the tubular portion 34 and the second air bearing 23 varies the outer diameter of the tubular portion 34, the clearance between the tubular portion 34 and the first air bearing 21 and the clearance between the tubular portion 34 and the second air bearing 23 will not vary.

(9) The permanent magnet 35 is fixed to the inner circumferential surface 341 of the tubular portion 34 by being press-fitted to part of the first inner circumferential surface 341a of the tubular portion 34 that is closer to the second inner circumferential surface 341b. Accordingly, the tubular portion 34 is less likely to be deformed as compared to a case in which, for example, the inner diameter of the inner circumferential surface 341 is constant from the first end 34a to the second end 34b, and the permanent magnet 35 starts being press-fitted to the inner circumferential surface 341 of the tubular portion 34 when starting to be inserted into the opening of the second end 34b of the tubular portion 34.

The above-described embodiment may be modified as follows. The above-described embodiment and the following modifications can be combined as long as the combined modifications remain technically consistent with each other.

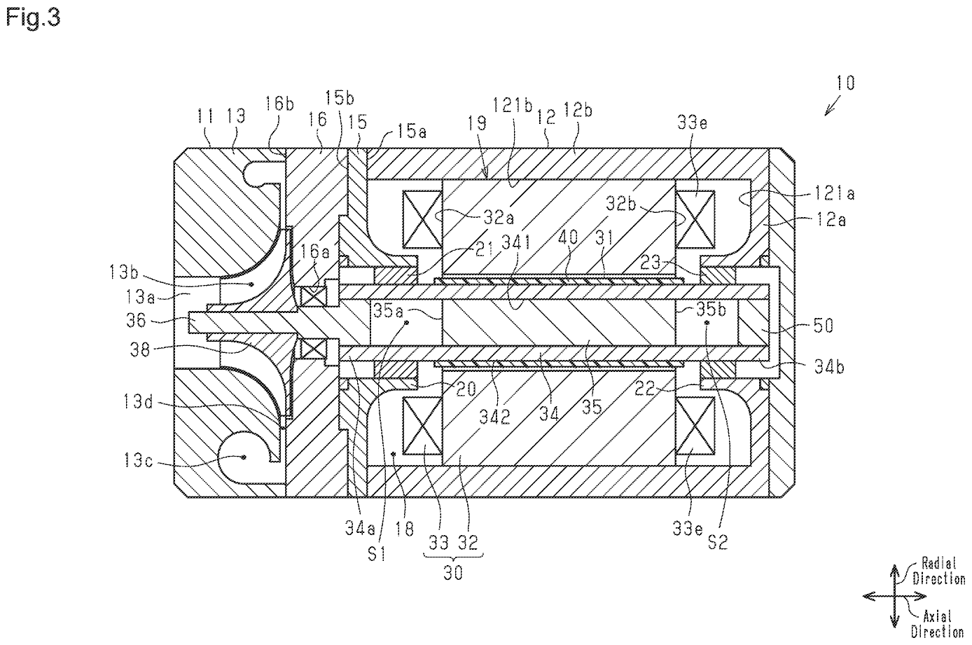

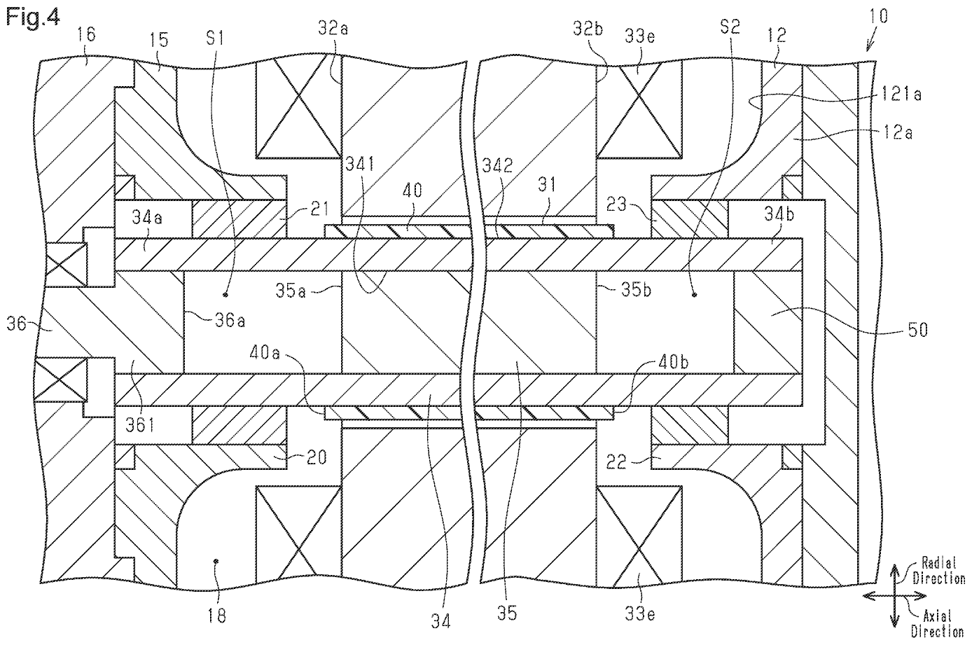

As shown in FIGS. 3 and 4, the fluid machine 10 may include only the first shaft member 36. In other words, the fluid machine 10 may include a plug to which an operating member can be attached at at least one of the opposite ends in the axial direction of the tubular portion 34. The first shaft member 36 is provided at the first end 34a of the tubular portion 34, and a closing member 50 is provided at the second end 34b of the tubular portion 34. The closing member 50 functions as a plug that closes the opening of the second end 34b. The closing member 50 is fixed to the inner circumferential surface 341 of the tubular portion 34 by being press-fitted into the second end 34b of the tubular portion 34. The closing member 50 at the second end 34b of the tubular portion 34 increases the stiffness of the second end 34b of the tubular portion 34. Accordingly, the tubular portion 34 is unlikely to be deformed. The closing member 50 does not necessarily need to be provided at the second end 34b of the tubular portion 34.

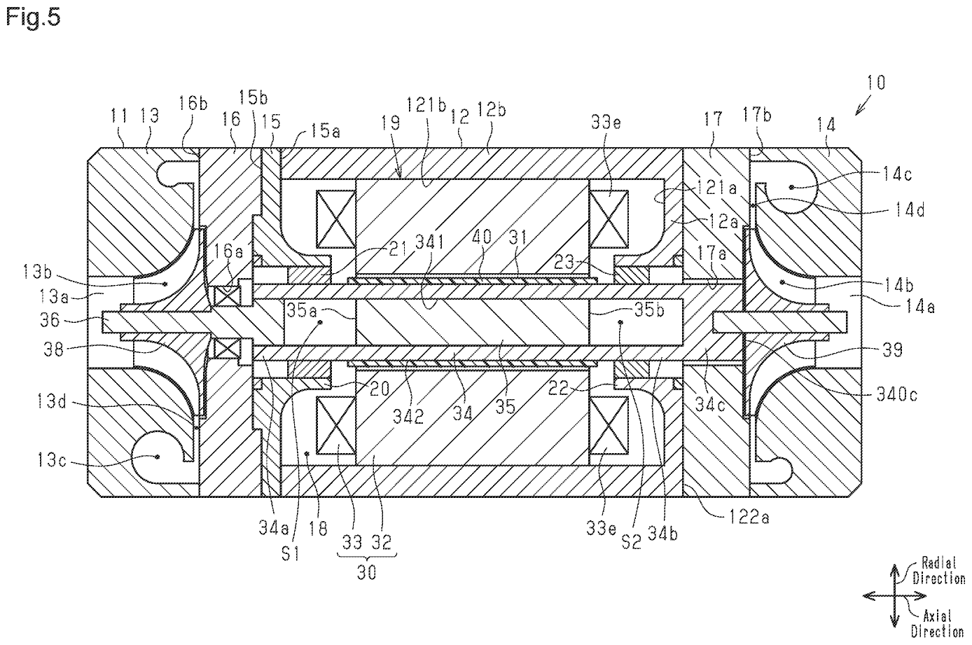

As shown in FIG. 5, the tubular portion 34 may include a bottom wall 34c, which functions as a plug. The bottom wall 34c is provided at the second end 34b of the tubular portion 34. The second impeller 39 is coupled to an end face 340c of the bottom wall 34c that is on the side opposite to the permanent magnet 35 in the axial direction of the tubular portion 34. The second impeller 39 is integrally rotatable with the bottom wall 34c of the tubular portion 34. This allows the tubular portion 34 to be coupled to the second impeller 39 without any component in between, eliminating the necessity to provide the second shaft member 37. Thus, the number of components is reduced. Further, the bottom wall 34c of the tubular portion 34 does not necessarily need to be provided at the second end 34b of the tubular portion 34, but may be provided at the first end 34a of the tubular portion 34.

In the embodiment, the first space S1 may be provided on the inner side of the tubular portion 34, and the second space S2 may be omitted. In other words, the embodiment may be modified as long as the permanent magnet 35 is spaced apart in the axial direction from a plug, so that a space is defined inside the tubular portion 34 by the tubular portion 34, the permanent magnet 35, and the plug.

In the embodiment, the first air bearing 21 supports the tubular portion 34 within the range in the axial direction of the first space S1, and the second air bearing 23 supports the tubular portion 34 within the range in the axial direction of the second space S2. However, the embodiment is not limited to this. For example, the first air bearing 21 may support the tubular portion 34 within the range of the length in the axial direction of the first space S1, and part of the second air bearing 23 may support the tubular portion 34 outside the range of the length in the axial direction of the second space S2. That is, the first space S1 may overlap with the entire first air bearing 21 when viewed in the radial direction of the tubular portion 34, and the second space S2 may overlap with part of the second air bearing 23 when viewed in the radial direction of the tubular portion 34. In other words, the embodiment may be modified as long as the first space S1 overlaps with at least part of the first air bearing 21 when viewed in the radial direction of the tubular portion 34, and the second space S2 overlaps with at least part of the second air bearing 23 when viewed in the radial direction of the tubular portion 34.

In the embodiment, the rotor 31 does not necessarily need to include the protective portion 40.

In the embodiment, the protective portion 40 is made of carbon fiber reinforced plastic. However, any material can be used as long as the material has a tensile strength greater than that of the tubular portion 34.

In the embodiment, the inner diameter of the inner circumferential surface 341 of the tubular portion 34 may be constant from the first end 34a to the second end 34b. In this case, the outer diameter the first fixing portion 361 of the first shaft member 36 is equal to the outer diameter of the second fixing portion 371 of the second shaft member 37.

In the embodiment, the bearings are not limited to the first air bearing 21 and the second air bearing 23, but may be plain bearings.

In the embodiment, the fluid machine 10 does not necessarily need to be mounted on a fuel cell vehicle, but may be employed for other purposes.

In the embodiment, the permanent magnet 35 may be replaced by a magnetic member such as a laminated core, an amorphous core, or a pressed powder core.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fluid machine, comprising:
a housing that includes an inner circumferential surface;
an operating member that is configured to draw fluid into and discharge the fluid from the housing; and
a motor that is accommodated in the housing and is configured to rotate the operating member, wherein
the motor includes:
a stator that is fixed to the inner circumferential surface of the housing and includes a stator core, the stator core including a first end face and a second end face, the second end face being on a side opposite to the first end face; and
a rotor that is arranged on a radially inner side of the stator, the rotor includes:
a tubular portion that includes an inner circumferential surface and includes, in an axial direction of the tubular portion, a first end and a second end, the second end being on a side opposite to the first end;
a magnetic member that is fixed to the inner circumferential surface of the tubular portion and includes a first end face and a second end face, the second end face being on a side opposite to the first end face; and
a plug provided at one of the first end and the second end of the tubular portion,
the fluid machine comprises two bearings that rotatably support the rotor,
the tubular portion includes a first portion that protrudes in the axial direction in relation to the first end face of the stator core and the first end face of the magnetic member,
the tubular portion includes a second portion that protrudes in the axial direction in relation to the second end face of the stator core and the second end face of the magnetic member,
the first portion and the second portion of the tubular portion are rotatably supported by the two bearings, respectively,
the magnetic member is spaced apart in the axial direction from the plug so that a space is defined inside the tubular portion by the tubular portion, the magnetic member, and the plug, and
one of the two bearings is provided on a radially outer side of the space.

2. The fluid machine according to claim 1, wherein
the plug is a first plug that is provided at the first end of the tubular portion, and the space is a first space,
the rotor further includes a second plug that is provided at the second end of the tubular portion,
a second space is defined in the tubular portion by the tubular portion, the magnetic member, and the second plug,
the first and second spaces are arranged at opposite ends in the axial direction of the magnetic member, and
the two bearings are arranged on a radially outer side of the first and second spaces, respectively.

3. The fluid machine according to claim 1, wherein
the space has a length in the axial direction, and
the bearing supports the tubular portion within a range of the length of the space.

4. The fluid machine according to claim 1, wherein
the rotor further includes a tubular protective portion that has a tensile strength greater than that of the tubular portion,
the tubular portion includes an outer circumferential surface, and
the protective portion is fixed to the outer circumferential surface of the tubular portion in a position overlapping with the magnetic member when viewed in the radial direction of the tubular portion.
